(19) United States
(12) Patent Application Publication
(10) Pub. No.: US 2017/0266583 A1
(43) Pub. Date: Sep. 21, 2017

(54) DISTRIBUTION DEVICE COMPRISING A DISTRIBUTOR WITH POLYGONAL CHANNELS AND CONTACTING ASSEMBLY COMPRISING SUCH A DISTRIBUTION DEVICE

(71) Applicant: L'Air Liquide, Societe Anonyme Pour I'Etude et I'Exploitation des Procedes Georges Claude, Paris (FR)

(72) Inventors: Frederic CRAYSSAC, Velizy (FR); Benoit DAVIDIAN, Saint Maur des Fosses (FR); Clement LIX, Versailles (FR); Bernard SAULNIER, La Garenne Colombes (FR); Mikael WATTIAU, Palaiseau (FR)

(73) Assignee: L'Air Liquide, Societe Anonyme Pour I'Etude et I'Exploitation des Procedes Georges Claude, Paris (FR)

(21) Appl. No.: 15/504,868

(22) PCT Filed: Aug. 20, 2015
(86) PCT No.: PCT/FR2015/052234

§ 371 Date: Feb. 17, 2017

(30) Foreign Application Priority Data
Aug. 20, 2014 (FR) 1457902

(51) Int. Cl. B01D 3/00; B01J 4/00; F28F 9/02

(52) U.S. Cl. CPC B01D 3/008; F28F 9/0278; F28F 9/0275; B01J 4/004; F28F 2275/085

(57) ABSTRACT

The invention relates to a distribution device having a container having side walls and a bottom with perforations; a distributor arranged beneath the container and provided with distribution channels that each have a polygonal cross-section; and mechanical connection bodies between the distributor and the linear elements, which extend beneath the distribution channels and fluidically connect the distribution channels to the linear elements when the distribution device is built into the contacting assembly.

### CROSS REFERENCE TO RELATED APPLICATIONS

This application is a §371 of International PCT Application PCT/FR2015/052234, filed Aug. 20, 2015, which claims the benefit of FR1457902, filed Aug. 20, 2014, both of which are herein incorporated by reference in their entireties.

### FIELD OF THE INVENTION

The present invention relates to a distribution device for distribution of a liquid on a plurality of vertical linear elements belonging to an assembly for putting liquid into contact with a gas. In addition, the present invention relates to a contacting assembly comprising such a distribution device.

The present invention can be applied to any physical, chemical or physical-chemical field in which a liquid and gas are put into contact, such as to exchange material and/or to exchange heat and/or to interact chemically and/or physically. In particular, the present invention can be applied to the fields of absorption, desorption, condensation, distillation, rectification, dust extraction, precipitation, or separation, for example cryogenic separation of the components of air. The flows of liquid and gas can run in counter-current or co-current form.

More particularly, the present invention can be applied to the design, production and repair of a distribution device and a contacting assembly comprising such a distribution device.

### BACKGROUND

US2007194471A1 describes an assembly for putting a liquid into contact with a gas, comprising a lining formed by vertical wires which extend along the entire length of the contacting assembly. The contacting assembly according to US2007194471A1 also comprises a liquid distributor which is situated above the vertical wires. The liquid distributor according to US2007194471A1 comprises parallel and vertical combs, to which adapters are coupled. The combs are immersed in channels where the liquid is located, and the adapters guide the liquid collected from the channels to the vertical wires.

However, a distributor according to the prior art distributes the liquid heterogeneously, which reduces the performance of the contacting assembly, since this heterogeneous distribution gives rise firstly to areas where there is little liquid or excess liquid, thus decreasing the efficiency of the contacting assembly, and secondly to an accumulation of liquid between vertical wires, which promotes choking between the vertical wires. In fact, the liquid flows partly to the side of the adapters without having been controlled, since the distribution of the adapters is not specific. In addition, the overflow of the liquid is not necessarily homogenous. Moreover, a distributor according to the prior art distributes a relatively small flow of liquid, since the adapters are very widely spaced.

### SUMMARY OF THE INVENTION

The objective of the present invention is in particular to solve the aforementioned problems entirely or partly by providing a distribution device which makes it possible to distribute the liquid spatially very regularly on the linear elements of the contacting assembly.

For this purpose, certain embodiments of the invention are related to a distribution device for distribution of a liquid on a plurality of substantially vertical linear elements, and belonging to an assembly for putting liquid into contact with at least one gas, the distribution device including at least:
a receptacle comprising lateral walls and a base which are configured to receive a volume of liquid to be distributed, the base having a plurality of perforations configured for the flow of liquid;
a distributor which is arranged below the receptacle when the distribution device is in the service position, the distributor having a plurality of distribution ducts which are configured to channel liquid flowing from the perforations by gravity, each distribution duct having a transverse cross-section with a polygonal form; and
connection units which are configured to permit mechanical connection between the distributor and the linear elements, the connection units extending below the distribution ducts, the connection units being configured to connect the distribution ducts flow-wise to the linear elements when the distribution device is integrated in the contacting assembly.

Thus, a distribution device of this type makes it possible to distribute the liquid in the contacting assembly spatially very regularly. In fact, in service, the liquid flows along the entire length of the ridges of the distribution ducts with polygonal cross-sections. Thus, the liquid does not flow, or flows only slightly, in the center of the distribution ducts. At the output from the distribution ducts, the liquid is distributed on the peripheral surface of each connection unit, and thus of each linear element belonging to the contacting assembly. In other words, the ridges of the distribution ducts with polygonal cross-sections guide the liquid towards the connection units, and from there to the linear elements.

The connection units make it possible to modulate the assembly of the linear elements independently from one another in the contacting assembly. Thus, a modular assembly of this type facilitates the construction of the contacting assembly.

The flow of the liquid in the distribution device, in particular through each perforation, is caused essentially by gravity, and optionally by the surface tension forces.

In the present application, the terms “underneath”, “below”, “above”, “bottom”, “top”, “lower” and “upper” refer to the altitude of a component relative to the altitude of another component, the altitudes being measured in the ascending vertical direction when the distribution device is in the service position.

In the present application, the term “linear element” designates in particular any element which extends globally according to a straight line. A linear element can have any form in transverse cross-section relative to the longitudinal direction. A linear element has transverse dimensions which are negligible in relation to its length; in other words, the linear element is thin and narrow. For example, a linear element can be formed by a wire, a bundle of wires, a cable, a band, a strip, a chain or another form. In the present application, the term “descending” refers to the field of terrestrial gravity.

A substantially vertical linear element forms an angle of between −80° and 80° with a vertical direction when the contacting assembly is in the service position.

According to a variant of the invention, the base of the receptacle is formed by at least one perforated plate placed close to the bottom of the lateral walls. Advantageously, the perforated plate has a flat lower face and a flat upper face. Thus, a plate of this type is simple to produce and assemble to the lateral walls of the receptacle. For example, the pierced plate can be formed by a metal grid.

As an alternative to a pierced plate, the base can be formed by a plate which is porous to the liquid. The porous plate can be formed by a sintered material, for example a metal material such as a stainless steel. For example, the porous plate can be formed by a metal foam.

Advantageously, the base of the receptacle has a relatively small thickness. However, the base of the receptacle can have a relatively large thickness. In other words, the base is thin, i.e. its thickness is slight in comparison with its length and/or its width.

According to a variant of the invention, the receptacle is globally in the form of a rectangular parallelepiped. Thus, a receptacle of this type is simple to produce and assemble in a contacting assembly.

According to an embodiment of the invention, the polygon which defines the transverse cross-section in the form of a polygon has a number of sides of less than 16, and preferably of less than 10. Advantageously, the polygon which defines the transverse cross-section in the form of polygon has a number of sides of less than 8, and preferably of less than 6. The smaller the number of sides, the smaller the angle between two sides. The effects of accumulation of liquid on a dihedron (corner) depend on the angle of this dihedron.

Thus, a polygon of this type concentrates the flows of liquid efficiently along the ridges of each transverse cross-section.

According to a variant of the invention, each distribution duct has a transverse cross-section substantially in the form of a rectangle, for example in the form of a square. As an alternative to this variant, each distribution duct can have a transverse cross-section substantially in the form of a triangle. Thus, a transverse cross-section of this type makes it possible to optimize the compactness of the distribution ducts. In fact, the distribution ducts can be placed in the form of a rectangular matrix.

According to an embodiment of the invention, the distribution ducts are substantially parallel to one another and to a longitudinal direction which is designed to be vertical when the distribution device is in the service position.

Thus, parallel and vertical distribution ducts of this type make it possible to minimize the losses of load in the flows of liquid.

According to an embodiment of the invention, each distribution duct is configured to be connected flow-wise to at least one perforation.

Thus, the perforations can fulfil a function of pre-distribution of the liquid between the distribution ducts, which makes it possible to increase the regularity of the spatial distribution of the liquid (isotropy).

According to an embodiment of the invention, each distribution duct has transverse dimensions, measured perpendicularly to the longitudinal direction, of between 0.5 mm and 20 mm, and each distribution duct has a length, measured parallel to the distribution direction, of between 1 mm and 100 mm.

Thus, transverse dimensions and lengths of this type allow the distribution device to supply with liquid linear elements which are very close to one another, which makes it possible to increase the performance of the contacting assembly.

According to an embodiment of the invention, each distribution duct is globally in the form of a prism.

Thus, a form of this type in the shape of the prism permits a vertical flow of the liquid, and therefore makes it possible to minimize the losses of load.

As an alternative or as a complement to the preceding embodiment, each distribution duct is globally in the form of a polyhedron converging towards the bottom of the respective distribution duct, for example a form of a truncated pyramid.

According to an embodiment of the invention, for at least one group of distribution ducts, each perforation is arranged opposite a respective distribution duct, when the distribution device is in the service position.

Thus, a perforation arrangement of this type makes possible a direct flow from the perforations in the distribution ducts, which minimizes the losses of load in the flow of liquid.

According to a variant of the invention, for all the distribution ducts, each perforation is arranged opposite a respective distribution duct when the distribution device is in the service position.

According to an embodiment of the invention, for at least one group of distribution ducts, each perforation is offset relative to each of the closest distribution ducts.

Thus, these offsettings between perforations and distribution ducts make it possible to increase the regularity of the pre-distribution of liquid put into effect by the perforations towards the distribution ducts. In fact, the liquid obtained from each perforation will fall onto an area of intersection between distribution ducts, and thus corners or ridges of the ducts which are very well wetted. Then, the liquid will flow equally well towards each nearby distribution duct. An area of intersection of this type can be formed by a flat surface or by a hollow which the liquid will fill regularly before exiting from it in an isotropic manner by overflow.

According to a variant of the invention, for all the distribution ducts, each perforation is offset relative to each of the closest distribution ducts.

According to an embodiment of the invention, each connection unit is arranged opposite a respective area of intersection situated between at least two respective distribution ducts.

In other words, each connection unit is arranged at an intersection between adjacent distribution ducts.

Thus, the connection units leave completely free the outputting section of each distribution duct, which makes it possible to minimize the losses of load whilst maximizing the regularity of the spatial distribution of the liquid.

According to an embodiment of the invention, the connection units comprise a plurality of connection pins, each connection pin having a peripheral surface which is connected flow-wise to said at least two respective distribution ducts.

Thus, connection pins of this type permit securing of the linear elements to the distribution device, whilst ensuring the regular passage of the liquid from the distribution ducts to the linear elements.

According to an embodiment of the invention, each peripheral surface comprises at least one lower portion globally in the form of a cylinder, for example with a circular base, extending substantially parallel to said at least two respective distribution ducts.

Thus, a cylindrical lower portion of this type makes it possible to generate few losses of load in the flow of liquid.

According to an embodiment of the invention, each peripheral surface comprises an upper portion which has a divergent form, for example frusto-conical, which diverges towards the bottom of the respective connection pin.

Because of this divergent form, a plurality of adjacent connection pins form a narrowing on the passage of the liquid obtained from the distribution ducts. Thus, a divergent form of this type makes it possible to maximize the wetting of each connection pin by the liquid.

According to a variant of the invention, the distribution ducts and/or the connection units are derived from an additive method, for example from three-dimensional printing.

According to an embodiment of the invention, each respective peripheral surface is totally in the form of a cylinder, for example with a circular base, the cylinder preferably being substantially tangent to respective walls belonging to said at least two respective distribution ducts.

Thus, a totally cylindrical form of this type minimizes the energy necessary for the liquid in order to cover the entire peripheral surface, which increases the regularity of the spatial distribution of the liquid (isotropy). In the case when the cylinder is tangent to distribution ducts, the liquid virtually does not change direction, and flows substantially vertically, which minimizes the losses of load.

According to an embodiment of the invention, each connection pin has transverse dimensions, measured perpendicularly to the longitudinal direction, of between 1 mm and 20 mm, and each connection pin has a length, measured parallel to the longitudinal direction, of between 1 mm and 100 mm.

Thus, transverse dimensions of this type and lengths of this type allow the distribution device to supply liquid to linear elements which are very close to one another, thus making it possible to increase the performance of the contacting assembly.

According to an embodiment of the invention, each connection pin has a receptacle which is configured to secure, for example by resilient snapping in or in the manner of a Morse taper, a respective connection joining piece which belongs to the contacting assembly, and supports at least one of said linear elements.

Thus, a receptacle of this type permits rapid and mechanically strong connection of each connection joining piece on the distribution device.

As an alternative to the preceding embodiment, some or all of the connection pins have a positioning receptacle configured to position a respective connecting joining piece which belongs to the contacting assembly, and supports at least one of said linear elements. Positioning receptacles of this type are used only to position the linear elements, without securing them. The contacting assembly can thus comprise securing units in order to secure the linear elements relative to the connection elements or to the distributor.

In addition, the present invention relates to an elementary component which is designed to form a distributor constituting a distribution device, each elementary component comprising a plurality of wings which are joined in a central region of the elementary component; each wing ending, opposite the central region, in a joining face which is configured to be attached, in a manner sealed against the liquid, to a corresponding joining face defined by a wing belonging to an adjacent elementary component. The wings are placed such as to form the distributor by attaching a plurality of elementary components according to their joining faces.

According to a variant, the elementary component comprises at least three wings. For example, the elementary component comprises six wings, which makes it possible to define triangular distribution ducts, after having attached a plurality of elementary components such as to form the distributor.

Thus, in a distribution device according to an embodiment of the invention, the distributor can comprise a plurality of these elementary components which are assembled such as to form the distribution ducts.

According to a variant, the wings are regularly distributed around the central region, in order to define a symmetrical polygonal cross-section for each distribution duct. According to a variant, the wings have the same length.

Alternatively, the wings can have different lengths and/or the wings can be distributed irregularly around the central region.

According to a variant, the distributor comprises a plurality of elementary components with geometries which are different from one another. Thus, the distributor can have distribution ducts with different geometries.

According to one embodiment, a plurality of distribution ducts, for example all of them, each have lateral notches which are configured to narrow the passage, and thus the outputting cross-section, on the course of the liquid between the linear elements.

In addition, certain embodiments of the present invention are for a contacting assembly which is configured to put at least one liquid into contact with at least one gas, for example for exchanges of heat and/or material between liquid and gas, the contacting assembly including at least:

i) a liquid inlet;

ii) a gas inlet; and

iii) linear elements which are substantially parallel to one another, such as to extend according to a longitudinal direction which is vertical when the contacting assembly is in the service position;

the contacting assembly being characterized in that it additionally comprises at least one distribution device according to the invention.

The linear elements are disjointed, since each linear element extends globally according to a straight line, and since the linear elements are substantially parallel to one another. Thus, the linear elements can define together a contact surface between liquid and gas which is very large, and in all cases larger than the contact surface which the plates would define, for the same size of the contacting assembly.

Thus, a contacting assembly of this type makes it possible to put a liquid and gas into contact with a very high-performance because of the great regularity of the spatial distribution of the liquid on the linear elements by the distribution device. When a contacting assembly of this type is in service, the linear elements can induce an efficient transfer of mass, with lateral sealing obtained since the linear elements are disjointed, as the distribution ducts and the connection units are separated from one another.

According to a variant, the linear elements comprise wires.

According to a variant the linear elements comprise solid linear elements, i.e. which are not hollow.

The aforementioned embodiments and variants can be taken in isolation or in any technically permissible combination.

### BRIEF DESCRIPTION OF THE DRAWINGS

The present invention will be well understood, and its advantages will also become apparent in the light of the following description, provided purely by way of non-limiting example with reference to the appended drawings, in which:

FIG. 1 is a schematic exploded view in perspective, truncated by a vertical plane II, of a distribution device according to a first embodiment of the invention;

FIG. 2 is a schematic view in cross-section according to the plane II in FIG. 1, of the distribution device in FIG. 1 in the disassembled state;

FIG. 3 is a view similar to FIG. 2 of the distribution device in FIG. 1 in the assembled state and in the service position;

FIG. 4 is a schematic view in perspective of the top of the distribution device in FIG. 3;

FIG. 5 is a schematic view in perspective of the bottom of the distribution device in FIG. 3;

FIG. 6 is a schematic side view of a contacting assembly according to the invention, comprising the distribution device in FIGS. 1 to 5;

FIG. 7 is a schematic view on an enlarged scale of the detail VII in FIG. 1;

FIG. 8 is a schematic view on an enlarged scale of the detail VIII in FIG. 2;

FIG. 9 is a schematic view of the bottom of a part of the distribution device in FIGS. 1 and 2;

FIG. 10 is a schematic view in perspective of the bottom of a part of a distribution device according to a second embodiment of the invention;

FIG. 11 is a schematic view of the top of a part of the distribution device in FIG. 10;

FIG. 12 is a view similar to FIG. 3, illustrating a distribution device according to a third embodiment of the invention; and

FIG. 13 is a view in perspective similar to FIG. 7, illustrating a distributor constituting a distribution device according to a fourth embodiment of the invention.

### DETAILED DESCRIPTION OF THE INVENTION

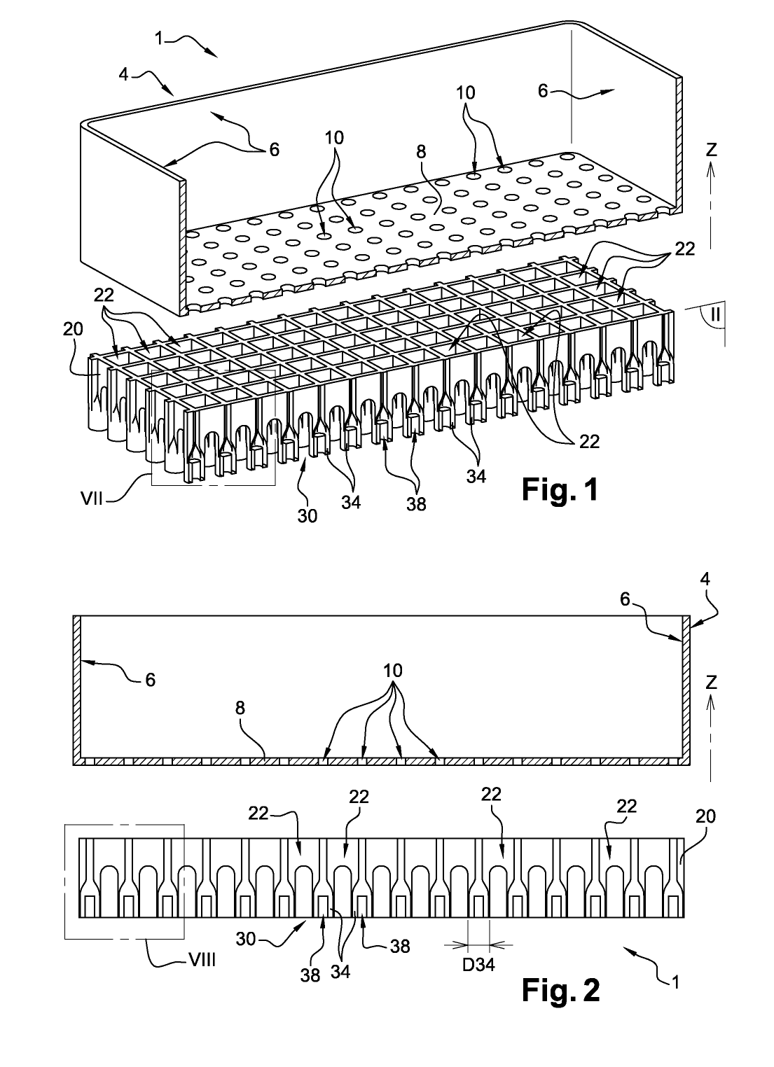

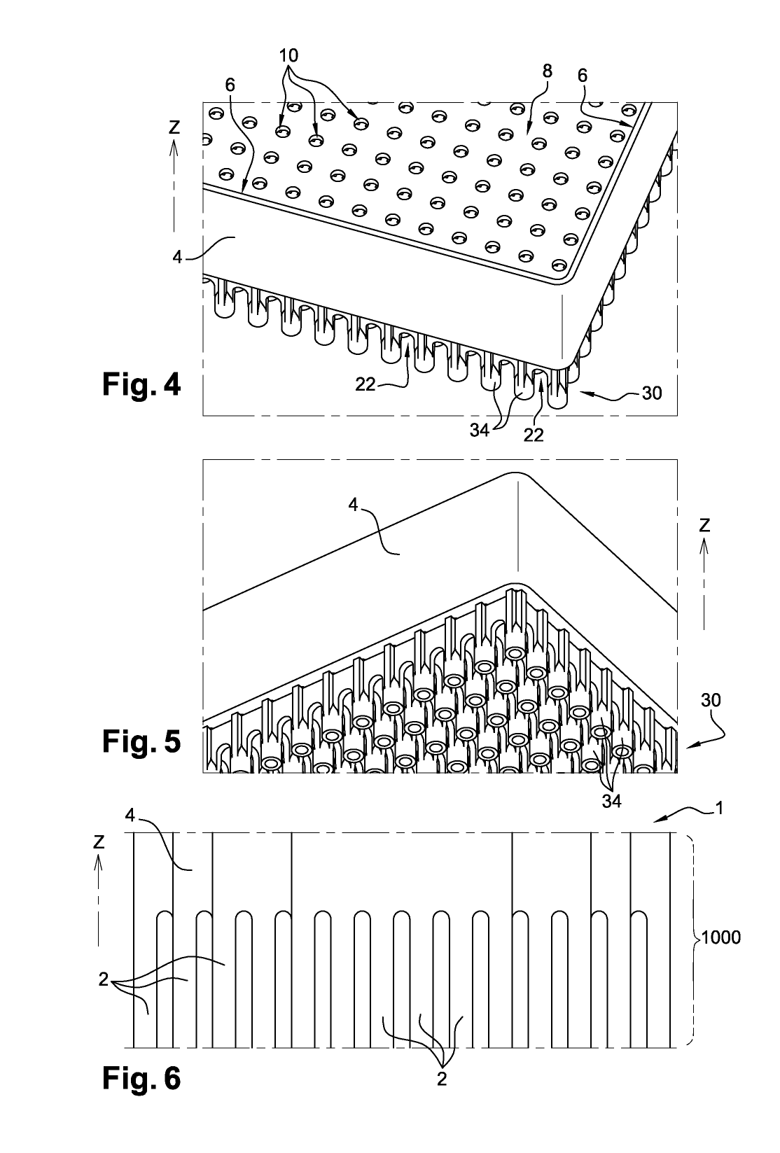

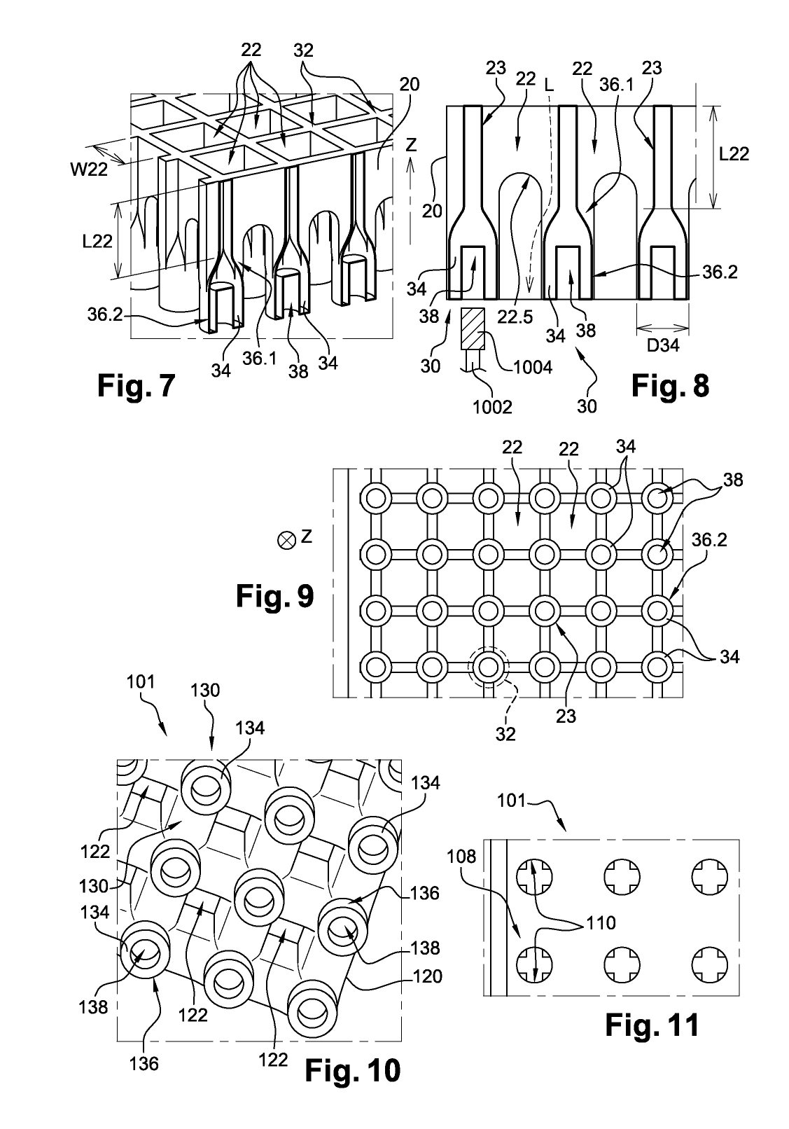

FIGS. 1, 2, 3, 4, 5, 6, 7, 8 and 9 illustrate a distribution device 1 for distribution of a liquid L on a plurality of linear elements 1002 which are substantially vertical, and belong to a contacting assembly 1000. Each linear element 1002 is in this case globally in the form of a wire. The linear elements 1002 are in this case substantially parallel to one another.

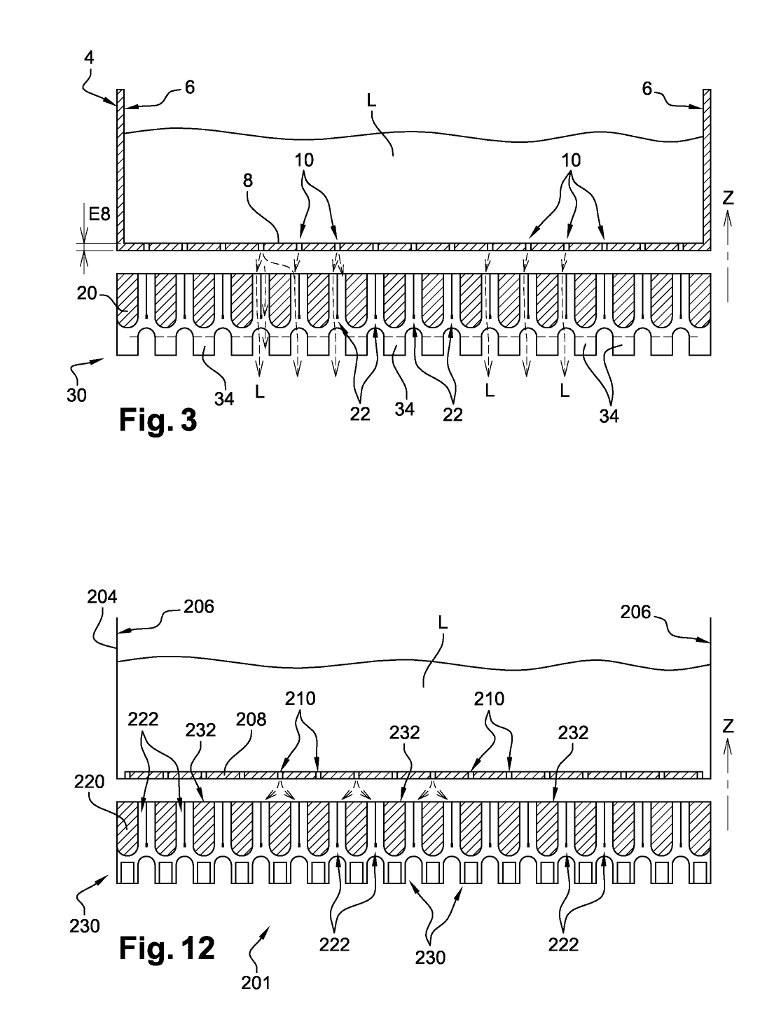

The contacting assembly 1000 is configured to put a liquid L, in this case liquid air, into contact with a gas, not represented, in this case gaseous air, for exchanges of heat and/or material between liquid L and gas. In FIG. 3, the flows of liquid L are represented by arrows in broken lines.

The distribution device 1 comprises in particular:
a receptacle 4 with perforations 10 for the liquid L;
a distributor 20 with distribution ducts 22; and
connection units 30 in order to connect the distribution ducts 22 to the linear elements 1002.

The receptacle 4 comprises lateral walls 6 and a base 8. The lateral walls 6 and the base 8 are configured to receive a predetermined volume of liquid L to be distributed. The base 8 has a plurality of perforations 10 which are configured for the flow of the liquid L. The receptacle 4 is in this case globally in the form of a rectangular parallelepiped.

In the example in FIG. 1, each perforation 10 is circular. For this purpose, the perforations 10 are through perforations, and each has a diameter or width equal to approximately 2.2 mm. The perforations 10 can be produced by a drill, a punch, a drilling laser beam, or any other equivalent means. In this case, the perforations 10 are distributed regularly on the base 8. In this case, the base 8 is formed by a perforated plate which is placed near the bottom of the lateral walls 6, and has a flat lower face and a flat upper face, as shown in FIG. 2. The base 8 can have a thickness E8 approximately equal to 1 mm.

The distributor 20 is arranged below the receptacle 4 when the distribution device 1 is in the service position (FIG. 3). The distributor 20 has a plurality of distribution ducts 22 which are configured to channel liquid L which flows from the perforations 10 by gravity. The distribution ducts 22 are placed in the form of a rectangular matrix which occupies the entire transverse cross-section of the distributor 20.

Each distribution duct 22 has a transverse cross-section in the form of a polygon, and in this case in the form of a square. The distribution ducts 22 are substantially parallel to one another and to a longitudinal direction Z. The distribution ducts 22 are in this case distributed regularly in the distributor 20.

The longitudinal direction Z is vertical when the distribution device 1 is in the service position (FIG. 3). The transverse cross-section of each distribution duct 22 is taken on a plane perpendicular to the longitudinal direction Z.

Each distribution duct 22 is configured to be connected fluid-wise to a perforation 10. When the distribution device 1 is in the service position (FIG. 3), each distribution duct 22 is connected fluid-wise mainly to a perforation 10, and secondarily to approximately eight adjacent perforations 10.

Each distribution duct 22 has globally a form in the shape of a prism, which has a square base (transverse cross-section) and is parallel to the longitudinal direction Z. Each distribution duct 22 has a width W22 equal to approximately 4.4 mm, measured perpendicularly to the longitudinal direction Z. Each distribution duct 22 has a length L22 equal to approximately 4.4 mm, measured parallel to the longitudinal direction Z.

For all the distribution ducts 22, each perforation 10 is arranged opposite a respective distribution duct 22 when the distribution device 1 is in the service position (FIG. 3).

The connection units 30 are configured to permit a mechanical connection between the distributor 20 and the linear elements 1002. The connection units 30 extend below the distribution ducts 22. The connection units 30 are configured to connect the distribution ducts 22 fluid-wise to the linear elements 1002 when the distribution device 1 is integrated in the contacting assembly 1000, as described hereinafter.

In the example in FIGS. 1 to 9, each connection unit 30 is arranged opposite a respective region of intersection 32, which is situated between four respective distribution ducts 22. The outputting section of each distribution duct 22 is thus completely cleared by the connection units 30. In other words, the connection units 30 are arranged alternately with the distribution ducts 22, in the manner of a checker board.

The connection units 30 in this case comprise a plurality of connection pins 34. Each connection pin 34 has a peripheral surface 36 which is connected fluid-wise to the four respective distribution ducts 22 which border the connection pin 34 concerned.

The connection pins 34 permit securing of the linear elements 1002 to the distribution device 1. For this purpose, each connection pin 34 has a receptacle 38 which is configured to secure, for example by resilient snapping in or in the manner of a Morse taper, a respective connection joining piece 1004, represented in FIG. 8, which belongs to the contacting assembly 1000 and supports one of the linear elements 1002.

As shown in FIGS. 1, 7 and 8, each peripheral surface 36 comprises an upper portion 36.1 with a frusto-conical form which diverges towards the bottom of the connection pin 34. These divergent forms of the adjacent connection pins form a narrowing on the passage of the liquid L obtained from the distribution ducts 22.

In addition, each respective peripheral surface 36 comprises a lower portion 36.2 globally in the form of a cylinder with a circular base extending substantially parallel to the respective distribution ducts 22, and thus to the longitudinal direction Z.

Each connection pin 34 has an outer diameter D34 approximately equal to 3 mm, measured on a plane perpendicular to the longitudinal direction Z and to the level of the lower portion 36.2. Each connection pin 34 has a length L34 equal to approximately 6 mm, measured parallel to the longitudinal direction Z, including an upper portion 36.1 and lower portion 36.2. Lateral notches 22.5 make it possible to narrow the passage on the course which the liquid could follow between the linear elements, which makes it possible to channel the liquid to the upper portion 36.1.

Four adjacent connection pins 34 border a respective distribution duct 22, extending its walls towards the bottom of the distribution device 1.

When the distribution device 1 is in service (FIG. 3), from the top to the bottom, a flow of liquid L flows along the walls of the distribution duct 22, mainly on and around its ridges 23. Then, the liquid L continues its path along the upper portion 36.1 and the lower portion 36.2. The connection pins 34 thus ensure a regular passage of the liquid L from the distribution ducts 22 to the connection units 30, and finally to the linear elements 1002.

In service, the distribution device 1 distributes the liquid L in the contacting assembly 1000 spatially very regularly. In fact, the liquid L flows along the entire length of the ridges of the distribution ducts 22 with square cross-sections. Thus, the liquid L flows only slightly, or not at all, in the center of the distribution ducts 22.

At the outlet of the distribution ducts 22, the liquid L is distributed on the peripheral surface 36 of each connection unit 30, and from there onto each linear element 1002.

The contacting assembly 1000 is configured to put the liquid L into contact with a gas, not represented, for exchanges of heat and/or material between liquid and gas. The contacting assembly 1000 comprises in particular:

i) a liquid inlet, formed by the receptacle 4;

ii) a gas inlet, not represented; and

iii) a plurality of linear elements 1002, which are parallel to one another such as to extend according to the longitudinal direction Z which is vertical when the contacting assembly 1000 is in the service position (FIG. 6).

The contacting assembly 1000 additionally comprises the distribution device 1 which is arranged above the linear elements 1002.

In addition, the contacting assembly 1000 also comprises:
an enclosure, not represented, which is sealed against the liquid and the gas, and has an elongate form parallel to the linear elements 1002; and
sealing units which are arranged around the assembly of the linear elements 1002, such as to prevent the gas from circulating in a gap which extends between the enclosure and the linear elements 1002.

FIGS. 10 and 11 illustrate a distribution device 101 according to a second embodiment of the invention. Since the distribution device 101 is similar to the distribution device 1, the description of the distribution device 1 previously given in relation with FIGS. 1 to 9 can be transposed to the distribution device 101, with the notable exception of the differences described hereinafter.

A component of the distribution device 101 which is identical or corresponds, by virtue of its structure or its function, to a component of the distribution device 1, bears the same numerical reference increased by 100.

There is thus definition of a base 108, perforations 110, a distributor 120, distribution ducts 122, connection units 130 with connection pins 134, and areas of intersection 132. Each connection pin 134 has a peripheral surface 136 and a receptacle 138.

The distribution device 101 differs from the distribution device 1, since each peripheral surface 136 of a respective connection pin 134 is totally in the form of a cylinder with a circular base, and parallel to the longitudinal direction Z. This cylinder is substantially tangent to respective walls belonging to four respective distribution channels 122.

As a result of this tangency, the connection pins 134 ensure a regular passage of the liquid L from the distribution ducts 122 to the linear elements 1002, without a significant change of direction, such that the liquid L flows substantially vertically when the distribution device 101 is in service.

FIG. 12 illustrates a distribution device 201 according to a second embodiment of the invention. Since the distribution device 201 is similar to the distribution device 1, the description of the distribution device 1 previously provided in relation with FIGS. 1 to 9 can be transposed to the distribution device 201, with the notable exception of the differences described hereinafter.

A component of the distribution device 201 which is identical or corresponds, by virtue of its structure or its function, to a component of the distribution device 1, bears the same numerical reference increased by 200. There is thus definition of a receptacle 204 with lateral walls 206 and a base 208, perforations 210, a distributor 220, distribution ducts 222 and connection units 230.

The distribution device 201 differs from the distribution device 1, since, for all the distribution ducts, each perforation 210 is offset relative to each of the closest distribution ducts 222.

Thus, when the distribution device 201 is in service, these offsettings between perforations 210 and distribution ducts 222 make it possible to increase the regularity of the pre-distribution of the liquid L provided by the perforations 210 towards the distribution ducts 222.

In fact, the liquid L obtained from each perforation 210 will fall onto an area of intersection 232 between distribution ducts 222. Then, the liquid L flows equally well towards each adjacent distribution duct 222.

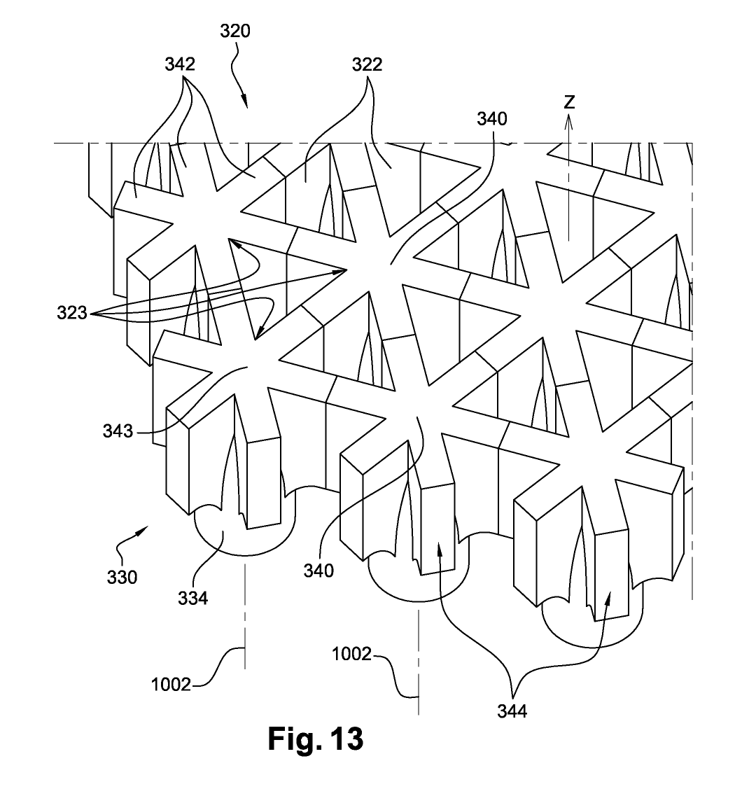

FIG. 13 illustrates a distributor 320 constituting a distribution device and a contacting assembly according to a fourth embodiment of the invention. Since the distributor 320 is similar to the distributor 20, the description of the distributor 20 previously given in relation with FIGS. 1 to 9 can be transposed to the distributor 320, with the notable exception of the differences described hereinafter.

A component of the distributor 320 which is identical or corresponds, by virtue of its structure or its function, to a component of the distributor 320 bears the same reference number increased by 300. This therefore defines distribution ducts 322 which each have ridges 323, and connection units 330 with connection pins 334.

The distributor 320 differs from the distributor 20, since each distribution duct 322 has a transverse cross-section substantially in the form of a triangle, which in this case is equilateral.

As for the connection pins 34, each connection pin 34 has a peripheral surface. However, since the transverse cross-section of each distribution duct 322 is substantially in the form of a triangle, each peripheral surface is connected fluid-wise to only three distribution ducts 322 which border the connection pin 34 concerned, whereas a peripheral surface 36 of a connection pin 34 is connected fluid-wise to four respective adjacent distribution ducts 22.

In addition, the distributor 320 comprises a plurality of elementary components 340 which are assembled such as to form the distribution ducts 322. Each elementary component 340 comprises six wings 342 which are joined in a central region 343 of the elementary component 340.

In this case, the wings 342 are distributed regularly around the central region 343 and the wings 342 have the same length, in order to define a cross-section in the form of an equilateral triangle for each distribution duct 322. Thus, each elementary component 340 has a form in the shape of a regular asterisk in transverse cross-section relative to the longitudinal direction Z.

Each wing 342 ends, opposite the central region 343, in a joining face 344 which is attached, in a manner sealed against the liquid L, to a corresponding joining face defined by a wing 342 belonging to an adjacent elementary component 340. By attaching all the elementary components 340 according to their joining faces 344, the distributor 320 is formed.

Similarly, the distributor 20 in FIGS. 1 to 9 can comprise a plurality of elementary components which are assembled such as to form the distribution ducts 22. Each elementary component thus comprises four wings which are joined in a central region of the elementary component. These wings are also regularly distributed around the central region and the wings also have the same length, in order to define a cross-section in the form of a square for each distribution duct 22. Each elementary component has a form in the shape of a cross or a cross-piece. Each wing of an elementary component which forms the distributor 20 ends, opposite the central region, in a joining face which is attached, in a manner sealed against the liquid L, to a corresponding joining face defined by a wing belonging to an adjacent elementary component. By attaching all these elementary components according to their joining faces, the distributor 20 can be formed.

It will be appreciated that the present invention is not limited to the particular embodiments described in the present patent application, or to embodiments within the scope of persons skilled in the art. Other embodiments can be envisaged without departing from the context of the invention, starting from any element which is equivalent to an element indicated in the present patent application.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-17. (canceled)

18. A distribution device for distribution of a liquid on a plurality of substantially vertical linear elements, and belonging to an assembly for putting liquid into contact with at least one gas, the distribution device comprising at least:
a receptacle comprising lateral walls and a base which are configured to receive a volume of liquid to be distributed, the base having a plurality of perforations configured for the flow of liquid;
a distributor which is arranged below the receptacle when the distribution device is in the service position, the distributor having a plurality of distribution ducts which are configured to channel liquid flowing from the perforations by gravity, each distribution duct having a transverse cross-section with a polygonal form; and
connection units which are configured to permit mechanical connection between the distributor and the linear elements, the connection units extending below the distribution ducts, the connection units being configured to connect the distribution ducts flow-wise to the linear elements when the distribution device is integrated in the contacting assembly.

19. The distribution device as claimed in claim 18, wherein the polygon which defines the transverse cross-section in the form of a polygon has a number of sides of less than 16.

20. The distribution device as claimed in claim 18, wherein the polygon which defines the transverse cross-section in the form of a polygon has a number of sides of less than 10.

21. The distribution device as claimed in claim 18, wherein the polygon which defines the transverse cross-section in the form of a polygon has a number of sides of less than 8.

22. The distribution device as claimed in claim 18, wherein the distribution ducts are substantially parallel to one another and to a longitudinal direction which is designed to be vertical when the distribution device is in the service position.

23. The distribution device as claimed in claim 18, wherein each distribution duct is configured to be connected fluid-wise to at least one perforation.

24. The distribution device as claimed in claim 23, wherein each distribution duct has transverse dimensions, measured perpendicularly to the longitudinal direction, of between 0.5 mm and 20 mm, and wherein each distribution duct has a length, measured parallel to the longitudinal direction, of between 1 mm and 100 mm.

25. The distribution device as claimed in claim 23, wherein each distribution duct has globally a form in the shape of a prism.

26. The distribution device as claimed in claim 18, wherein, for at least one group of distribution ducts, each perforation is arranged opposite a respective distribution duct, when the distribution device is in the service position.

27. The distribution device as claimed in claim 18, wherein, for at least one group of distribution ducts, each perforation is offset relative to each of the closest distribution ducts.

28. The distribution device as claimed in claim 18, wherein each connection unit is arranged opposite a respective area of intersection situated between at least two respective distribution ducts.

29. The distribution device as claimed in claim 28, wherein the connection units comprise a plurality of connection pins, each connection pin having a peripheral surface which is connected flow-wise to said at least two respective distribution ducts.

30. The distribution device as claimed in claim 29, wherein each peripheral surface comprises at least one lower portion globally in the form of a cylinder, for example with a circular base, extending substantially parallel to said at least two respective distribution ducts.

31. The distribution device as claimed in claim 30, wherein each peripheral surface comprises an upper portion which has a divergent form, for example frusto-conical, which diverges towards the bottom of the respective connection pin.

32. The distribution device as claimed in claim 30, wherein each peripheral surface is totally in the form of a cylinder having a circular base.

33. The distribution device as claimed in claim 32, the cylinder being substantially tangent to respective walls belonging to said at least two respective distribution ducts.

34. The distribution device as claimed in claim 29, wherein each connection pin has transverse dimensions, measured perpendicularly to the longitudinal direction, of between 1 mm and 20 mm, and wherein each connection pin has a length, measured parallel to the longitudinal direction, of between 1 mm and 100 mm.

35. The distribution device as claimed in claim 29, wherein each connection pin has a receptacle which is configured to secure, for example by resilient snapping in or in the manner of a Morse taper, a respective connection joining piece which belongs to the contacting assembly, and supports at least one of said linear elements.

36. The distribution device as claimed in claim 18, wherein a plurality of distribution ducts, for example all of them, each have lateral notches which are configured to narrow the passage on the course of the liquid between the linear elements.

37. A contacting assembly which is configured to put at least one liquid into contact with at least one gas, the contacting assembly comprising at least:
i) a liquid inlet;
ii) a gas inlet; and
iii) linear elements which are substantially parallel to one another, such as to extend according to a longitudinal direction which is vertical when the contacting assembly is in the service position,
wherein the contacting assembly further comprises at least one distribution device according to claim 18.
